(19) United States
(12) Patent Application Publication
(10) Pub. No.: US 2008/0031166 A1
(43) Pub. Date: Feb. 7, 2008

(54) Bidirectional transmission circuit and sending/receiving element

(75) Inventor: Takatoshi Fukuda, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/648,658

(22) Filed: Jan. 3, 2007

(30) Foreign Application Priority Data
Aug. 3, 2006 (JP) 2006-211875

(51) Int. Cl. H04J 15/00

(52) U.S. Cl. 370/297

(57) ABSTRACT

According to the present invention, in order to simultaneously realize high-speed transmission suppressing signal reflection and reduction of power consumption, a bidirectional transmission circuit, in which a plurality of sending/receiving elements send and receive signals via a transmission bus, is constructed so that, when a first sending/receiving element operates as a sending side, a first control unit sets a connection of the transmission bus to a first termination voltage source via a first terminating resistor by a first switch to off and a second control unit sets a connection of the transmission bus to a second termination voltage source via a second terminating resistor by a second switch to on.

### BACKGROUND OF THE INVENTION

1) Field of the Invention

The present invention relates to a bidirectional transmission circuit of SSTL (Stab Series Terminated Logic) in which a plurality of sending/receiving elements mutually send and receive a signal via a transmission bus.

2) Description of the Related Art

FIG. 2 shows a configuration of a conventional SSTL (Stab Series Terminated Logic) bidirectional transmission circuit (hereinafter referred to simply as a transmission circuit) 100. As shown in FIG. 2, the conventional transmission circuit 100 comprises a transmission bus 101 for transferring a signal, a first sending/receiving element 110 and a second sending/receiving element 120 that can mutually send and receive a signal via the transmission bus 101, a signal line 102 for sending a Write/Read signal (sending/receiving switching signal) from the first sending/receiving element 110 to the second sending/receiving element 120, a terminating resistor 132 interposed between the transmission bus 101 and a first sending/receiving element 110 and connected to a termination voltage source (denoted by “Vtt” in the diagram) 131 on a first sending/receiving element 110 side, and a terminating resistor 142 interposed between the transmission bus 101 and a second sending/receiving element 120 and connected to a termination voltage source (denoted by “Vtt” in the diagram) 141 on the second sending/receiving element 120 side.

The first sending/receiving element 110 and the second sending/receiving element 120 have the same configuration. The first sending/receiving element 110 is comprised of a driver 111 for outputting a signal, a resistor 112 as an output impedance of the driver 111, and a receiver 113 for receiving a signal.

The second sending/receiving element 120 is comprised of a driver 121 for outputting a signal, a resistor 122 as an output impedance of the driver 121, and a receiver 123 for receiving a signal.

Here, faster data transfer can be realized in data transfer by using higher frequencies. However, as the frequency of a signal increases, signal reflection tends to occur more frequently at an input/output end 114 or 124 of the first sending/receiving element 110 or the second sending/receiving element 120 respectively, preventing normal data transfer. Thus, in the conventional SSTL transmission circuit 100, signal reflection is reduced at the input/output ends 114 and 124 of the first sending/receiving element 110 and the second sending/receiving element 120 by providing the terminating resistors 132 and 142 connected to the termination voltage sources 131 and 141 respectively at both ends of the transmission bus 101.

If, in the transmission circuit 100, for example, a supply voltage is 2.5 V, a characteristic impedance of a transmission line of the transmission bus 101 is 50Ω, the termination voltage sources 131 and 141 have 1.25 V, the terminating resistors 132 and 142 have 50Ω, and the resistors 112 and 122 have 25Ω, and a signal is sent from the first sending/receiving element 110 to the second sending/receiving element 120 via the transmission bus 101 (that is, a Write (sending) signal is sent from the first sending/receiving element 110 to the second sending/receiving element 120 via the Write/Read signal line 102), the voltage at the input/output end 124 of the second sending/receiving element 120 becomes 1.875 V when a signal level is a high level and the voltage at the input/output end 124 becomes 0.625 V when a signal level is a low level so that normal data transfer (that is, signal sending from the first sending/receiving element 110 to the second sending/receiving element 120) can be realized.

However, an electric current that flows at this time through the output end of the driver 111 of the first sending/receiving element 110 becomes ±25 mA, which is a fairly large current.

By providing the terminating resistors 132 and 142 connected to the termination voltage sources 131 and 141 at both ends of the transmission bus 101, as described above, signal reflection can be reduced, but on the other hand, power consumption increases.

Moreover, though not shown in FIG. 2, if a plurality (for example, 32 or 64) of transmission buses 101 are disposed between the first sending/receiving element 110 and the second sending/receiving element 120 in the transmission circuit 100 and data transfer is carried out by the plurality of transmission buses 101 (that is, used as data buses), a fairly big noise is produced when the plurality of transmission buses 101 are simultaneously switched, because the electric current flowing through the output end of the driver 111 is ±25 mA, which is a large value.

A technique is available in which, by providing switches between the terminating resistors 132 and 142 and the termination voltage sources 131 and 141 respectively, high-speed data transfer at high frequencies is realized by setting these switches to on in high-speed transfer mode, while low-speed transfer at low frequencies is realized by setting these switches to off in low-speed transfer mode (for example, see Japanese Patent Application Laid-Open No. 10-20974 shown below).

In the conventional transmission circuit 100 described above, most desired is to realize both high-speed transfer of data (signal) and reduction of power consumption at the same time.

However, according to the technique disclosed in Japanese Patent Application Laid-Open No. 10-20974 described above, power consumption can be reduced to suppress signal reflection by switching to the low-speed transfer mode, but the data transfer speed decreases due to data transfer at low frequencies where signal reflection can be suppressed.

That is, according to the technique disclosed in Japanese Patent Application Laid-Open No. 10-20974 described above, high-speed transfer of data suppressing signal reflection and reduction of power consumption cannot be realized simultaneously.

### SUMMARY OF THE INVENTION

The present invention has been developed in consideration of the above problem and an object thereof is to enable realization of high-speed transmission suppressing signal reflection and reduction of power consumption simultaneously in a bidirectional transmission circuit in which a plurality of sending/receiving elements send and receive a signal via a transmission bus.

To achieve the above object, a bidirectional transmission circuit having a first sending/receiving element and a second sending/receiving element that can send and receive a signal mutually via a transmission bus that transmits the signal, further comprises a first terminating resistor corresponding to the first sending/receiving element that is connected to a first termination voltage source to prevent reflection of a signal sent via the transmission bus, a second terminating resistor corresponding to the second sending/receiving element that is connected to a second termination voltage source to prevent reflection of a signal sent via the transmission bus, a first switch for switching on/off of a connection of the transmission bus to the first termination voltage source via the first terminating resistor, a second switch for switching on/off of a connection of the transmission bus to the second termination voltage source via the second terminating resistor, a first control unit for controlling switching of on/off of the connection by the first switch, and a second control unit for controlling switching of on/off of the connection by the second switch, wherein if the first sending/receiving element operates as a sending side, the first control unit sets the connection by the first switch to off and the second control unit sets the connection by the second switch to on.

It is preferable to have the first sending/receiving element being provided internally with the first terminating resistor, the first switch, and the first control unit and the second sending/receiving element being provided internally with the second terminating resistor, the second switch, and the second control unit.

It is preferable for the first control unit to control switching of on/off of the connection by the first switch based on a sending/receiving switching signal generated by the first sending/receiving element.

Moreover, it is preferable for the second control unit to control switching of on/off of the connection by the second switch based on the sending/receiving switching signal issued by the first sending/receiving element.

Also, to achieve the above object, a sending/receiving element of the present invention capable of sending and receiving a signal mutually with another sending/receiving element connected via a transmission bus that transmits the signal comprises a terminating resistor connected to a termination voltage source to prevent reflection of a signal sent via the transmission bus, a switch to switch on/off of a connection of the transmission bus to the termination voltage source via the terminating resistor, and a control unit to control switching of on/off of the connection by the switch, wherein the control unit sets the connection by the switch to off, when it operates as a sending side for the other sending/receiving element and the control unit sets the connection by the switch to on, when it operates as a receiving side for the other sending/receiving element.

According to the present invention, as described above, when the first sending/receiving element operates as a sending side, the first control unit cuts off the connection of the transmission bus to the first termination voltage source via the first terminating resistor by setting the connection by the first switch to off and the second control unit sets the connection of the transmission bus to the second termination voltage source via the second terminating resistor to on by setting the connection by the second switch to on; thus, data sending can be performed reliably without a signal from the first sending/receiving element to the second sending/receiving element being reflected even if the data sending from the first sending/receiving element to the second sending/receiving element is high-speed transmission using signals at high frequencies.

In addition, since, at this time, the first terminating resistor on the sending side of the transmission bus is cut off from the transmission bus by the first control unit and only the second terminating resistor on the receiving side of the transmission bus is connected to the transmission bus by the second control unit, an electric current flowing in the bidirectional transmission circuit caused by signal transmission from the first sending/receiving element to the second sending/receiving element can be made smaller than that by the conventional technique described with reference to the above FIG. 2, thereby realizing low power consumption.

That is, according to the present invention, high-speed transmission suppressing signal reflection and reduction of power consumption can be realized simultaneously.

### BRIEF DESCRIPTION OF THE DRAWINGS

FIG. 1 is a diagram showing a configuration of a bidirectional transmission circuit as an embodiment of the present invention; and

FIG. 2 is a diagram showing a configuration of a conventional bidirectional transmission circuit.

### DESCRIPTION OF PREFERRED EMBODIMENTS

An embodiment of the present invention will be described below with reference to drawings.

### [1] An Embodiment of the Present Invention

[1-1] Configuration

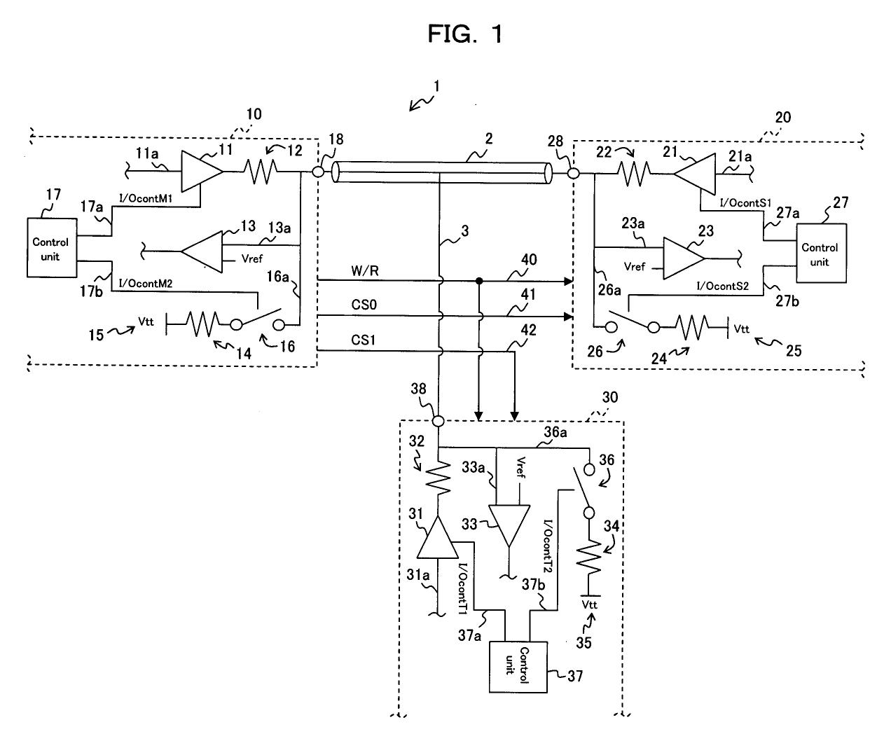

First, a configuration of a bidirectional transmission circuit 1 as an embodiment of the present invention will be described with reference to FIG. 1.

As show in FIG. 1, a bidirectional transmission circuit 1 is comprised of a transmission bus 2, a signal line 3, a first sending/receiving element 10, a second sending/receiving element 20, a third sending/receiving element 30, a Write/Read signal line (hereinafter referred to as a control signal line) 40, a first CS (Chip Select) signal line 41, and a second CS signal line 42.

The transmission bus 2 transmits (transfers) signals (data) in both directions.

The first sending/receiving element 10 is an element (chip; for example, the CPU (Central Processing Unit) side) connected to one end of the transmission bus 2 to operate as a main control side (master side). That is, the first sending/receiving element 10 operates as the main control side to control switching of sending/receiving of signals with respect to other sending/receiving elements (here, the second sending/receiving element 20 and third sending/receiving element 30).

Then, the second sending/receiving element 20 is an element (chip; for example, the memory side) connected to the other end of the transmission bus 2 to operate as a subordinate side (slave side) whose switching of sending/receiving of signals is controlled by the first sending/receiving element 10 on the main control side.

Also, the third sending/receiving element 30 is an element (chip; for example, the memory side) connected in midstream of the transmission bus 2 via the signal line 3 to function as a subordinate side with respect to the first sending/receiving element 10 on the main control side and performs at least sending/receiving of data with the first sending/receiving element 10.

The signal line 3 is longer than the transmission bus 2 in FIG. 1, but in fact, the signal line 3 is preferably very short relative to the transmission bus 2. This will lead to realization of more stable sending/receiving of signals.

Then, the control signal line 40 is a signal line to send from the first sending/receiving element 10 to the second sending/receiving element 20 and third sending/receiving element 30 a sending/receiving switching signal W/R (Write/Read signal; denoted by “W/R” in the diagram), issued by the first sending/receiving element 10, for controlling switching of sending (that is, Write) of data from the first sending/receiving element 10 to the second sending/receiving element 20 and third sending/receiving element 30 and reception (that is, Read).

The first CS signal line 41 is a signal line to send from the first sending/receiving element 10 to the second sending/receiving element 20 a first selection signal CS0 (denoted by “CS0” in the diagram) issued by the first sending/receiving element 10 together with a sending/receiving switching signal W/R, for the first sending/receiving element 10 to select the second sending/receiving element 20 as a sending/receiving partner of data.

The second CS signal line 42, on the other hand, is a signal line to send from the first sending/receiving element 10 to the third sending/receiving element 30 a second selection signal CS1 (denoted by “CS1” in the diagram), issued by the first sending/receiving element 10 together with a sending/receiving switching signal W/R, for the first sending/receiving element 10 to select the third sending/receiving element 30 as a sending/receiving partner of data.

Next, parts related to sending/receiving of signals of each of the first sending/receiving element 10, second sending/receiving element 20, and third sending/receiving element 30 will be described. Such parts are constructed similarly for each of the first sending/receiving element 10, second sending/receiving element 20, and third sending/receiving element 30.

That is, the first sending/receiving element 10 is comprised of a driver 11, a resistor 12, a receiver 13, a terminating resistor (first terminating resistor) 14, a termination voltage source (first termination voltage source) 15, a switch (first switch) 16, a control unit (first control unit) 17, and an input/output end (pin) 18; the second sending/receiving element 20 is comprised of a driver 21, a resistor 22, a receiver 23, a terminating resistor (second terminating resistor) 24, a termination voltage source (second termination voltage source) 25, a switch (second switch) 26, a control unit (second control unit) 27, and an input/output end (pin) 28; and the third sending/receiving element 30 is comprised of a driver 31, a resistor 32, a receiver 33, a terminating resistor (third terminating resistor) 34, a termination voltage source (third termination voltage source) 35, a switch (third switch) 36, a control unit (third control unit) 37, and an input/output end (pin) 38.

Here, each of components of the first sending/receiving element 10 to the third sending/receiving element 30 with the exception of the control units 17, 27, and 37 (denoted below by reference numerals “17 to 37”) operates similarly or approximately similarly and such similarly operating components will be described collectively below.

First, the drivers 11, 21, and 31 (denoted below by reference numerals “11 to 31”) are used to output signals and output a data signal based on a signal (first I/O cont signal; I/O cont M1 signal for the driver 11, I/O cont S1 signal for the driver 21, and I/O cont T1 signal for the driver 31) from the control units 17 to 37 input via signal lines 17a, 27a, and 37a (denoted below by reference numerals “17a to 37a”) and input from an upstream side via signal lines 11a, 21a, and 31a (denoted below by reference numerals “11a to 31a”) respectively.

Here, if “1” is input as a first I/O cont signal, the drivers 11 to 31 become active and output the high level (supply voltage; for example, 2.5 V when the supply voltage is 2.5 V) or low level (GND; 0 V) based on input from the upstream side via the signal lines 11a to 31a.

If “0” is input as a first I/O cont signal, on the other hand, the drivers 11 to 31 become passive and do not operate.

Though omitted in FIG. 1 for simplification of the diagram, for example, an operation unit is connected on the upstream side of the signal line 11a of the driver 11 in the first sending/receiving element 10 and from there, data (here, data sent to the second sending/receiving element 20 and third second sending/receiving element 30) is input into the driver 11 via the signal line 11a.

Also, a storage unit for retaining data, for example, is connected on the upstream side of the signal lines 21a and 31a of the drivers 21 and 31 in the second sending/receiving element 20 and third sending/receiving element 30 respectively and from there, data (for example, data sent to the first sending/receiving element 10) is input into the drivers 21 and 31 via the signal lines 21a and 31a respectively.

The resistors 12, 22, and 32 (denoted below by reference numerals “12 to 32”) are resistors provided on an output side of the drivers 11 to 31 respectively.

Here, the resistor 12 of the first sending/receiving element 10 and the resistor 22 of the second sending/receiving element 20 are set to resistance that is equal to characteristic impedance of the transmission bus 2, and the resistance of the resistor 32 of the third sending/receiving element 30 is set smaller (here, half) than that of the resistors 12 and 22.

The receivers (comparators) 13, 23, and 33 (denoted below by reference numerals “13 to 33”) are used to receive a signal input via the transmission bus 2 and the input/output ends 18, 28, and 38 (denoted below by reference numerals “18 to 38”).

That is, the receivers 13 to 33 are constructed so that, after comparing a signal (input voltage) input via the signal lines 13a, 23a, and 33a (denoted below by reference numerals “13a to 33a”) input from the input/output ends 18 to 38 with a reference voltage (denoted by “Vref” in the diagram; 1.25 V when the supply voltage is 2.5 V) respectively, the receivers 13 to 33 output “0” if the input voltage is lower than the reference voltage, and “1” if the input voltage is higher than the reference voltage.

The terminating resistors 14, 24, and 34 (denoted below by reference numerals “14 to 34”) are connected to the termination voltage sources 15, 25, and 35 (denoted below by reference numerals “15 to 35”) respectively to prevent reflection of a signal sent (input) by any of other sending/receiving elements 10, 20, and 30 via the transmission bus 2 and the input/output ends 18 to 38.

More specifically, as shown in FIG. 1, the terminating resistors 14 to 34 are provided inside the first sending/receiving element 10 to third sending/receiving element 30 respectively and are connected to the input/output ends 18 to 38 situated farthest inside the first sending/receiving element 10 to third sending/receiving element 30 by signal lines 16a, 26a, and 36a (denoted below by reference numerals “16a to 36a”) via the switches 16, 26, and 36 (denoted below by reference numerals “16 to 36”) respectively.

Each of the terminating resistors 14 to 34 is set to a value that is equal to characteristic impedance of the transmission bus 2.

Each of the termination voltage sources 15 to 35 is set to an intermediate value of the supply voltage, that is, to 1.25 V if the supply voltage is 2.5 V.

The switches 16 to 36 are used to turn on/off connection (that is, connection/disconnection) between the signal lines 16a to 36a and the terminating resistors 14 to 34 respectively and switch on/off based on a signal (second I/O cont signal; I/O cont M2 signal for the switch 16, I/O cont S2 signal for the switch 26, and I/O cont T2 signal for the switch 36) from the control units 17 to 37 input via input lines 17b, 27b, and 37b respectively.

That is, the switches 16 to 36 switch on/off of connection of the transmission bus 2 to the termination voltage sources 15 to 35 via the terminating resistors 14 to 34 respectively.

Here, the switches 16 to 36 are constructed as high-speed analog switches that set connection to on when “1” is input as a second I/O cont signal and off when “0” is input as a second I/O cont signal.

Next, each of the control units 17 to 37 will be described.

The control unit 17 of the first sending/receiving element 10 is used to control switching of an active/passive state of the driver 11 and switching of on/off of the switch 16 based on a sending/receiving switching signal W/R for switching sending/receiving of data with respect to the second sending/receiving element 20 or third sending/receiving element 30 generated by, for example, the operation unit (not shown) in the first sending/receiving element 10.

More specifically, if a sending/receiving switching signal W/R produced (generated) by the first sending/receiving element 10 to control switching of sending/receiving of signals is “1,” which indicates sending of a signal (that is, when the first sending/receiving element 10 is to operate as a sending side of data), the control unit 17 sends out “1” as an I/O cont M1 signal to bring the driver 11 to an active state to the driver 11 via the signal line 17a and further sends out “0” as an I/O cont M2 signal to turn off the switch 16 to the switch 16 via the signal line 17b.

If, on the other hand, a sending/receiving switching signal W/R generated by the first sending/receiving element 10 to control switching of sending/receiving of signals is “0,” which indicates reception of a signal (that is, when the first sending/receiving element 10 is to operate as a receiving side of data), the control unit 17 sends out “0” as an I/O cont M1 signal to bring the driver 11 to a passive state to the driver 11 via the signal line 17a and further sends out “1” as an I/O cont M2 signal to turn on the switch 16 to the switch 16 via the signal line 17b.

The control unit 17 generates, based on the sending/receiving switching signal W/R, an I/O cont M1 signal according to the following logical formula (1) and an I/O cont M2 signal according to the following logical formula (2).
I/O cont M1=W/R (1)
I/O cont M2=not (W/R) (2)

The control unit 27 of the second sending/receiving element 20 is used to control switching of the active/passive state of the driver 21 and on/off of the switch 26 based on the sending/receiving switching signal W/R input from the first sending/receiving element 10 via the control signal line 40 and the first selection signal CS0 generated by the operation unit of the first sending/receiving element 10 together with the sending/receiving switching signal W/R and input via the first CS signal line 41 for selecting the second sending/receiving element 20.

More specifically, if the first selection signal CS0 input via the first CS signal line 41 is “1,” which indicates that the first sending/receiving element 10 has selected the second sending/receiving element 20 as a sending/receiving partner and the sending/receiving switching signal W/R is “1,” which indicates that the first sending/receiving element 10 operates as the sending side (that is, the second sending/receiving element 20 is the receiving side), the control unit 27 issues “0” to the driver 21 via the signal line 27a as an I/O cont S1 signal to bring the driver 21 to a passive state and issues “1” to the switch 26 via the signal line 27b as an I/O cont S2 signal to turn on the switch 26.

If the first selection signal CS0 is “1” and the sending/receiving switching signal W/R is “0,” which indicates that the first sending/receiving element 10 operates as the receiving side (that is, the second sending/receiving element 20 is the sending side), the control unit 27 sends out “1” to the driver 21 via the signal line 27a as an I/O cont S1 signal to bring the driver 21 to an active state and “0” to the switch 26 via the signal line 27b as an I/O cont S2 signal to turn off the switch 26.

Moreover, if the first selection signal CS0 is “0,” which indicates that the first sending/receiving element 10 has not selected the second sending/receiving element 20 as a sending/receiving destination (that is, the third sending/receiving element 30 has been selected as a sending/receiving destination) and the sending/receiving switching signal W/R is “1,” which indicates that the first sending/receiving element 10 operates as the sending side, the control unit 27 sends out “0” as an I/O cont S1 signal to bring the driver 21 to a passive state and “1” as an I/O cont S2 signal to turn on the switch 26.

If, on the other hand, the first selection signal CS0 is “0” and the sending/receiving switching signal W/R is “0,” which indicates that the first sending/receiving element 10 operates as the receiving side, the control unit 27 also sends out “0” as an I/O cont S1 signal to bring the driver 21 to a passive state and “1” as an I/O cont S2 signal to turn on the switch 26.

The control unit 27 generates, based on the sending/receiving switching signal W/R and first selection signal CS0, an I/O cont S1 signal according to the following logical formula (3) and an I/O cont S2 signal according to the following logical formula (4).
I/O cont S1=not (W/R) and CS0 (3)
I/O cont S2=W/R or (not (W/R) and not (CS0)) (4)

The control unit 37 of the third sending/receiving element 30 is used to control switching of the active/passive state of the driver 31 based on the sending/receiving switching signal W/R input from the first sending/receiving element 10 via the control signal line 40 and the second selection signal CS1 generated by the operation unit of the first sending/receiving element 10 together with the sending/receiving switching signal W/R and input via the second CS signal line 42 for selecting the third sending/receiving element 30.

More specifically, if the second selection signal CS1 input via the second CS signal line 42 is “1,” which indicates that the first sending/receiving element 10 has selected the second sending/receiving element 20 as a sending/receiving partner and the sending/receiving switching signal W/R is “1,” which indicates that the first sending/receiving element 10 operates as the sending side (that is, the third sending/receiving element 30 is the receiving side), the control unit 37 sends out “0” to the driver 31 via the signal line 37a as an I/O cont T1 signal to bring the driver 31 to a passive state.

If, on the other hand, the second selection signal CS1 is “1” and the sending/receiving switching signal W/R is “0,” which indicates that the first sending/receiving element 10 operates as the receiving side (that is, the third sending/receiving element 30 is the sending side), the control unit 37 sends out “1” to the driver 31 via the signal line 37a as an I/O cont T1 signal to bring the driver 31 to a passive state.

The control unit 37 always sends out “0” as an I/O cont T2 signal to always turn off the switch 36 regardless of the sending/receiving switching signal W/R and second selection signal CS1 from the first sending/receiving element 10.

The control unit 37 generates, based on the sending/receiving switching signal W/R and the second selection signal CS1, an I/O cont T1 signal according to the following logical formula (5) and an I/O cont T2 signal according to the following logical formula (6).
I/O cont T1=not (W/R) and CS1 (5)
I/O cont T2=0 (6)

[1-2] Operation Examples

Next, concrete operation examples of the present bidirectional transmission circuit 1 will be described.

Here, it is assumed that the supply voltage is 2.5 V, characteristic impedance of the transmission bus 2 is 50Ω, the resistors 12 and 22 have 50Ω, the resistor 32 has 25Ω, the terminating resistors 14 to 34 have 50Ω, the termination voltage sources 15 to 35 have 1.25 V, and if the drivers 11 to 31 are active (when the first I/O cont signal is “1”), output impedance thereof is 0Ω and if the drivers 11 to 31 are passive (when the first I/O cont signal is “0”), output impedance thereof is in a high impedance state.

[1-2-1] When the First Sending/Receiving Element 10 and the Second Sending/Receiving Element 20 Send and Receive Signals to Each Other

First, a case in which a signal is sent (that is, data is written) from the first sending/receiving element 10 to the second sending/receiving element 20 will be described. In this case, “1” is output as a sending/receiving switching signal W/R and “1” as a first selection signal CS0 from the first sending/receiving element 10, and then the driver 11 is controlled to switch to an active state and the switch 16 to off by the control unit 17, and the driver 21 is controlled to switch to a passive state and the switch 26 to on by the control unit 27. At this time, “0” is output as a second selection signal CS1 from the first sending/receiving element 10, then the driver 31 is controlled to switch to a passive state and the switch 36 is set to off by the control unit 37.

Then, the terminating resistor 14 in the first sending/receiving element 10 on the sending side of signals is separated from the transmission bus 2 by the control unit 17 and the terminating resistor 24 in the second sending/receiving element 20 on the receiving side of signals is connected to the transmission bus 2 by the control unit 27.

If, at this time, the driver 11 is outputting a high-level signal (2.5 V), input of the receiver 23 of the second sending/receiving element 20, which is the subordinate side, becomes 1.875 V and if the driver 11 is outputting a low-level signal (0 V), input of the receiver 23 becomes 0.625 V.

Therefore, the receiver 23 can reliably determine whether such input (1.875 V or 0.625 V) is “1” or “0” based on the reference voltage 1.25 V, and data sending is reliably performed without a signal from the first sending/receiving element 10 to the second sending/receiving element 20 being reflected.

Moreover, at this time, the voltage (potential) at the input/output end 28 of the second sending/receiving element 20, which is the receiving side of signals, is 1.875 V or 0.625 V, the terminating resistor 14 of the first sending/receiving element 10 on the sending side (upstream side in the transmission direction of signals) of the transmission bus 2 is not connected to the transmission bus 2, and only the terminating resistor 24 (50Ω) connected to the termination voltage source (1.25 V) of the second sending/receiving element 20 on the receiving side (downstream side in the transmission direction of signals) of the transmission bus 2 is connected to the transmission bus 2; thus, the electric current flowing through an output end of the driver 11 becomes ±12.5 mA, realizing low power consumption.

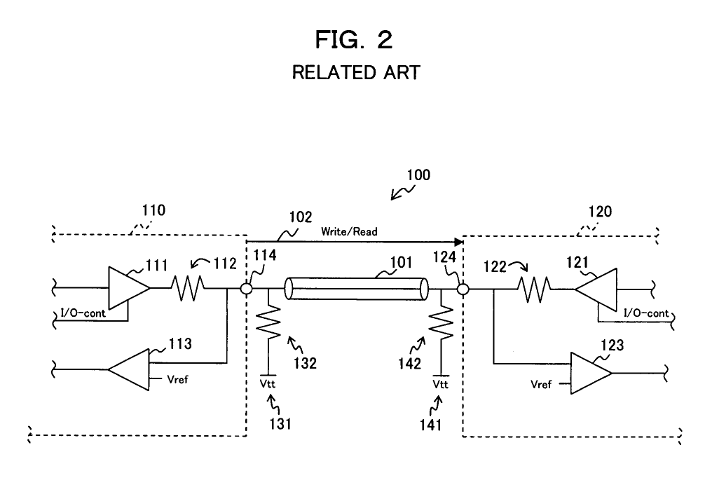

That is, as described with reference to the above FIG. 2, in a conventional technique in which the terminating resistors 132 and 142 are connected to the termination voltage sources 131 and 141 respectively at both ends of the sending and receiving sides of the transmission bus 101, the electric current flowing through the output end of the driver 111 is ±25 mA, but in the present bidirectional transmission circuit 1, the electric current flowing through the output end of the driver 11 under the same conditions (that is, the supply voltage (2.5 V) and the characteristic impedance (50Ω) of the transmission bus 2 are the same) is reduced to ±12.5 mA, halving the power consumption in comparison with the conventional technique.

If the first sending/receiving element 10 operates as the receiving side and the second sending/receiving element 20 operates as the sending side (that is, if the first sending/receiving element 10 reads data from the second sending/receiving element 20), the driver 11 is controlled to switch to a passive state and the switch 16 to on by the control unit 17 and the driver 21 is controlled to switch to an active state and the switch 26 to off by the control unit 27, causing the input of the receiver 13 of the first sending/receiving element 10 to take 1.875 V when a high-level signal is output from the driver 21 and 0.625 V when a low-level signal is output from the driver 21; thus, data sending can reliably be performed without a signal from the second sending/receiving element 20 to the first sending/receiving element 10 being reflected.

Moreover, the electric current flowing through the output end of the driver 21 will be ±12.5 mA so that low power consumption can be realized.

[1-2-2] When the First Sending/Receiving Element 10 and the Third Sending/Receiving Element 30 Send and Receive Signals to Each Other

Next, a case in which a signal is sent (that is, data is written) from the first sending/receiving element 10 to the third sending/receiving element 30 will be described. In this case, “1” is output as a sending/receiving switching signal W/R and “1” as a second selection signal CS1 from the first sending/receiving element 10, and then the driver 11 is controlled to switch to an active state and the switch 16 to off by the control unit 17 and the driver 31 is controlled to switch to a passive state and the switch 36 to on by the control unit 37. At this time, “0” is output as a first selection signal CS0 from the first sending/receiving element 10, and then the driver 21 is controlled to switch to a passive state and the switch 26 to on by the control unit 27.

That is, the terminating resistor 14 in the first sending/receiving element 10 on the sending side of signals is separated from the transmission bus 2 by the control unit 17 and the terminating resistor 34 in the third sending/receiving element 30 on the receiving side of signals is not connected to the transmission bus 2 by the control unit 37, but the terminating resistor 24 of the second sending/receiving element 20 is connected to the transmission bus 2.

Here, since the resistor 32 in the third sending/receiving element 30 has 25Ω and the terminating resistor 24 (50Ω) connected to the termination voltage source 25 (1.25 V) of the second sending/receiving element 20 is connected to the transmission bus 2, input of the receiver 33 of the third sending/receiving element 30, which is the subordinate side, becomes 1.875 V if the driver 11 is outputting a high-level signal (2.5 V), and input of the receiver 33 becomes 0.625 V if the driver 11 is outputting a low-level signal (0 V), and thus, like signal transmission between the first sending/receiving element 10 and second sending/receiving element 20 described above, data sending is reliably performed without a signal from the first sending/receiving element 10 to the third sending/receiving element 30 being reflected.

Moreover, at this time, the electric current flowing through the output end of the driver 11 will be ±12.5 mA so that, like signal transmission between the first sending/receiving element 10 and second sending/receiving element 20 described above, low power consumption can be realized.

If the first sending/receiving element 10 operates as the receiving side and the third sending/receiving element 30 operates as the sending side (that is, if the first sending/receiving element 10 reads data from the third sending/receiving element 30), the driver 11 is controlled to switch to a passive state and the switch 16 to on by the control unit 17, the driver 2 is controlled to switch to an passive state and the switch 26 to on by the control unit 27, and the driver 31 is controlled to switch to an active state and the switch 36 to off by the control unit 37, causing the input of the receiver 13 of the first sending/receiving element 10 to take 1.875 V when a high-level signal is output from the driver 31 and 0.625 V when a low-level signal is output from the driver 31; thus, data sending is reliably performed without a signal from the third sending/receiving element 30 to the first sending/receiving element 10 being reflected.

[1-3] Effects

According to the bidirectional transmission circuit 1 as an embodiment of the present invention, as described above, if the first sending/receiving element 10 performs signal transmission with the second sending/receiving element 20 via the transmission bus 2 and the first sending/receiving element 10 operates as the sending side, the control unit 17 cuts off the connection of the transmission bus 2 to the termination voltage source 15 via the terminating resistor 14 by turning off the switch 16, and the control unit 27 sets the connection of the transmission bus 2 to the termination voltage source 25 via the terminating resistor 24 to on by turning on the switch 26; thus, data sending is reliably performed without a signal from the first sending/receiving element 10 to the second sending/receiving element 20 being reflected even if the data sending from the first sending/receiving element 10 to the second sending/receiving element 20 is high-speed transmission using signals at high frequencies.

Moreover, at this time, the terminating resistor 14 on the sending side of the transmission bus 2 is separated from the transmission bus 2 by the control unit 17 and only the terminating resistor 24 on the receiving side of the transmission bus 2 is connected to the transmission bus 2 by the control unit 27; thus, the electric current flowing (that is, the electric current at the output end of the driver 11) in the bidirectional transmission circuit 1 caused by data sending from the first sending/receiving element 10 to the second sending/receiving element 20 will be half that of the conventional technique described with reference to the above FIG. 2 under the same conditions to realize low power consumption and, as a result, an occurrence of noise and EMI (Electro Magnetic Interference) caused by simultaneous switching when there are a plurality (for example, 32 or 64) of other transmission buses (illustration omitted) between the first sending/receiving element 10 and second sending/receiving element 20 can be reduced.

In other words, when data sending/receiving is performed between the first sending/receiving element 10 and second sending/receiving element 20, since the control unit 17 controls the driver 11 and the switch 16 and the control unit 27 controls the driver 21 and the switch 26, high-speed transmission using signals at high frequencies can be realized with lower power consumption while suppressing signal reflection, that is, high-speed transmission suppressing signal reflection and reduction of power consumption can be realized simultaneously.

Since the terminating resistor 14, the switch 15, and the control unit 17 are provided inside the first sending/receiving element 10, the terminating resistor 24, the switch 25, and the control unit 27 are provided inside the second sending/receiving element 20, and the terminating resistor 34, the switch 35, and the control unit 37 are provided inside the third sending/receiving element 30, each of the sending/receiving elements 10, 20, and 30 can be realized using the same sending/receiving element, leading to improved productivity.

Though there is a difference in part of operations between the second sending/receiving element 20 and third sending/receiving element 30, the difference can be reconciled by adopting a configuration in which output impedance of the drivers 11 to 31 can be changed and a configuration in which operations of the switches 16 to 36 can be changed by settings of external signals or internal registers (illustration omitted) to realize each of the sending/receiving elements 10, 20, and 30 using a sending/receiving element of the same configuration.

Also, since the control unit 17 of the first sending/receiving element 10, which operates as a main control side to control switching of sending/receiving of signals with respect to other sending/receiving elements (here, the second sending/receiving element 20 and third sending/receiving element 30) controls switching of on/off of connection of the switch 16 based on the sending/receiving switching signal W/R generated in the first sending/receiving element 10 to control switching of sending/receiving of signals with other sending/receiving elements (here, the second sending/receiving element 20 and third sending/receiving element 30), switching of the switch 16 can be performed reliably.

Moreover, since the control unit 27 of the second sending/receiving element 20, which operates as a subordinate side whose switching of sending/receiving of signals is controlled by the first sending/receiving element 10, controls switching of on/off of the switch 26 based on the sending/receiving switching signal W/R issued by the first sending/receiving element 10 via the control signal line 40 to control switching of sending/receiving, switching of the switch 26 can be performed reliably.

In addition, since the control unit 27 of the second sending/receiving element 20 controls switching of on/off of the switch 26 based on the first selection signal CS0 from the first sending/receiving element 10, which operates as the sending side, via the first CS signal line 41, switching of the switch 26 can reliably be performed.

The control unit 27 of the second sending/receiving element 20 sets connection by the switch 26 to on based on the sending/receiving switching signal W/R and first selection signal CS0 when sending/receiving of signals between the first sending/receiving element 10 and third sending/receiving element 30 is performed, the control unit 17 sets connection by the switch 16 to off when the first sending/receiving element 10 operates as the sending side with respect to the third sending/receiving element 30, and the control unit 17 sets connection by the switch 26 to on when the first sending/receiving element 10 operates as the receiving side with respect to the third sending/receiving element 30; thus, an effect similar to that when sending/receiving of data between the first sending/receiving element 10 and second sending/receiving element 20 is performed can also be obtained when sending/receiving of data between the third sending/receiving element 30, which is connected in midstream of the transmission bus 2, and first sending/receiving element 10 is performed.

That is, when sending/receiving of data between the first sending/receiving element 10 and third sending/receiving element 30 is performed, high-speed transmission using signals at high frequencies can also be performed with lower power consumption while suppressing signal reflection.

### [2] Others

The present invention is not limited to the embodiment but can be carried out in various forms without deviating from the spirits of the present invention.

For example, in the embodiment, an example in which the third sending/receiving element 30 is comprised of the terminating resistor 34, the termination voltage source 35, and the switch 36 (that is, an example realized using the same sending/receiving element having a similar configuration for a portion related to sending/receiving of the first sending/receiving element 10 to third sending/receiving element 30) was taken for description, but the present invention is not limited to this and the third sending/receiving element 30 connected in midstream of the transmission bus 2 may not comprise the terminating resistor 34, the termination voltage source 35, or the switch 36.

Also in the embodiment, an example in which the terminating resistors 14 to 34, the termination voltage sources 15 to 35, the switches 16 to 36, and the control units 17 to 37 are provided in the first sending/receiving element 10 to third sending/receiving element 30 respectively was taken for description, the present invention is not limited to this and these terminating resistors 14 to 34, termination voltage sources 15 to 35, switches 16 to 36, and control units 17 to 37 may be provided outside the first sending/receiving element 10 to third sending/receiving element 30 respectively. In this case, the signal lines 16a and 26a connecting the transmission bus 2 and the switches 16 and 26 are preferably connected to a signal line between the input/output ends 18 and 28 and the transmission bus 2 respectively, and the signal line 36a connecting the signal line 3 connected to the transmission bus 2 and the switch 36 is preferably connected to the signal line 3.

In addition, in the embodiment, an example in which the bidirectional transmission circuit 1 is comprised of three sending/receiving elements of the first sending/receiving element 10 to third sending/receiving element 30 was taken for description, but the present invention is not limited to this and the bidirectional transmission circuit in the present invention may be comprised of two sending/receiving elements of the first sending/receiving element 10 and second sending/receiving element 20 or a plurality of sending/receiving elements having the same configuration and functions as those of the third sending/receiving element 30 connected in midstream of the transmission bus 2, and the number of sending/receiving elements provided in the bidirectional transmission circuit of the present invention is not limited in the present invention.

What is claimed is:

1. A bidirectional transmission circuit having a first sending/receiving element and a second sending/receiving element that can mutually send and receive a signal via a transmission bus that transmits the signal, comprising:
a first terminating resistor corresponding to said first sending/receiving element, connected to a first termination voltage source to prevent reflection of a signal sent via said transmission bus;
a second terminating resistor corresponding to said second sending/receiving element, connected to a second termination voltage source to prevent reflection of a signal sent via said transmission bus;
a first switch for switching on/off of a connection of said transmission bus to said first termination voltage source via said first terminating resistor;
a second switch for switching on/off of a connection of said transmission bus to said second termination voltage source via said second terminating resistor;
a first control unit for controlling switching of on/off of said connection by said first switch; and
a second control unit for controlling switching of on/off of said connection by said second switch, wherein
said first control unit sets said connection by said first switch to off and said second control unit sets said connection by said second switch to on, when said first sending/receiving element operates as a sending side.

2. The bidirectional transmission circuit according to claim 1, wherein said first terminating resistor, said first switch, and said first control unit are provided inside said first sending/receiving element, and said second terminating resistor, said second switch, and said second control unit are provided inside said second sending/receiving element.

3. The bidirectional transmission circuit according to claim 1, wherein said first control unit controls switching of on/off of said connection by said first switch based on a sending/receiving switching signal generated by said first sending/receiving element.

4. The bidirectional transmission circuit according to claim 3, wherein said second control unit controls switching of on/off of said connection by said second switch based on said sending/receiving switching signal issued by said first sending/receiving element.

5. The bidirectional transmission circuit according to claim 4, wherein said second control unit controls switching of on/off of said connection by said second switch based on a selection signal for specifying a sending destination issued by said first sending/receiving element operating as a sending side.

6. The bidirectional transmission circuit according to claim 2, wherein said first control unit controls switching of on/off of said connection by said first switch based on a sending/receiving switching signal issued by said first sending/receiving element.

7. The bidirectional transmission circuit according to claim 6, wherein said second control unit controls switching of on/off of said connection by said second switch based on said sending/receiving switching signal issued by said first sending/receiving element.

8. The bidirectional transmission circuit according to claim 7, wherein said second control unit controls switching of on/off of said connection by said second switch based on a selection signal for specifying a sending destination issued by said first sending/receiving element operating as a sending side.

9. The bidirectional transmission circuit according to claim 1, further comprising a third sending/receiving element connected in midstream of said transmission bus and capable of mutually sending and receiving a signal at least with said first sending/receiving element, wherein
said second control unit sets said connection by said second switch to on, when said first sending/receiving element and said third sending/receiving element send and receive a signal, and
said first control unit sets said connection by said first switch to off when said first sending/receiving element operates as the sending side with respect to said third sending/receiving element and said first control unit sets said connection by said first switch to on, when said first sending/receiving element operates as a receiving side with respect to said third sending/receiving element.

10. The bidirectional transmission circuit according to claim 9, wherein said first control unit controls switching of on/off of said connection by said first switch based on a sending/receiving switching signal generated by said first sending/receiving element.

11. The bidirectional transmission circuit according to claim 10, wherein said second control unit controls switching of on/off of said connection by said second switch based on said sending/receiving switching signal issued by said first sending/receiving element.

12. A sending/receiving element capable of sending and receiving a signal mutually with another sending/receiving element connected via a transmission bus that transmits the signal, comprising:
a terminating resistor connected to a termination voltage source to prevent reflection of a signal sent via said transmission bus;
a switch to switch on/off of a connection of said transmission bus to said termination voltage source via said terminating resistor; and
a control unit to control switching of on/off of said connection by said switch, wherein
said control unit sets said connection by said switch to off when said sending/receiving element operates as a sending side with respect to said other sending/receiving element and said control unit sets said connection by said switch to on, when said sending/receiving element operates as a receiving side with respect to said other sending/receiving element.

13. The sending/receiving element according to claim 12, wherein said control unit controls switching of on/off of said connection by said switch based on a sending/receiving switching signal generated to control switching of sending/receiving of signals with said other sending/receiving element, when said sending/receiving element operates as a main control side controlling switching of sending/receiving of signals with said other sending/receiving element.

14. The sending/receiving element according to claim 12, wherein said control unit controls switching of on/off of said connection by said switch based on said sending/receiving switching signal to control switching of sending/receiving issued by said other sending/receiving element, when said sending/receiving element operates as a subordinate side whose switching of sending/receiving of signals is controlled by said other sending/receiving element.

15. The sending/receiving element according to claim 12, wherein said control unit controls switching of on/off of said connection by said switch based on a selection signal for specifying a sending destination issued by said other sending/receiving element, when said sending/receiving element operates as a subordinate side whose switching of sending/receiving of signals is controlled by said other sending/receiving element.
